(19) United States
(12) Patent Application Publication
(10) Pub. No.: US 2020/0145639 A1
(43) Pub. Date: May 7, 2020

(54) PORTABLE 3D SCANNING SYSTEMS AND SCANNING METHODS

(71) Applicant: Guangdong Kang Yun Technologies Limited, Guangzhou City (CN)

(72) Inventor: Seng Fook Lee, Guangzhou City (CN)

(21) Appl. No.: 16/616,185

(22) PCT Filed: Jun. 15, 2018
(86) PCT No.: PCT/CN2018/091587

§ 371 Date: Nov. 22, 2019

Related U.S. Application Data
(60) Provisional application No. 62/590,372, filed on Nov. 24, 2017.

(51) Int. Cl. H04N 13/221; G01S 17/894; G01B 11/24; H04N 5/232

(52) U.S. Cl. CPC H04N 13/221; G01S 17/894; G01B 2210/54; H04N 5/23238; G01B 2210/52; G01B 11/24

(57) ABSTRACT

A portable 3D scanner including a camera for capturing a plurality of image shots of an object for scanning is provided. The camera being mounted on a stack structure configured to expand and close for adjusting a height and an angle of the camera for taking at least one image shot of the plurality of image shots of the object. The stack structure is mounted over a base comprising wheels for movement of the base to multiple positions. The further comprising a processor for: determining a laser center of the object from a first image shot; determining a radius between the object and the a center of the camera, the base may move around the object based on the radius for covering a 360-Degree view of the object; and processing and stitching the plurality of image shots for generating a 3D scanned image of the object.

### CROSS REFERENCE TO RELATED APPLICATIONS

This application is a national stage application under 35 U.S.C. 371 of PCT Application No. PCT/CN2018/091587, filed 15 Jun. 2018, which PCT application claimed the benefit of U.S. Provisional Patent Application No. 62/590,372, filed 24 Nov. 2017, the entire disclosure of each of which are hereby incorporated herein by reference.

### TECHNICAL FIELD

The presently disclosed embodiments relate to the field of imaging and scanning technologies. More specifically, embodiments of the present disclosure relate to portable three-dimensional (3D) scanning systems and scanning methods for generating 3D scanned images of an object.

### BACKGROUND

A three-dimensional (3D) scanner may be a device capable of analysing environment or a real-world object for collecting data about its shape and appearance, for example, colour, height, length width, and so forth. The collected data may be used to construct digital three-dimensional models. Usually, 3D laser scanners create “point clouds” of data from a surface of an object. Further, in the 3D laser scanning, physical object's exact size and shape is captured and stored as a digital 3-dimensional representation. The digital 3-dimensional representation may be used for further computation. The 3D laser scanners work by measuring a horizontal angle by sending a laser beam all over the field of view. Whenever the laser beam hits a reflective surface, it is reflected back into the direction of the 3D laser scanner.

The existing portable 3D scanners or systems suffer from multiple limitations. For example, the 3D scanner remains stationary, and the object is placed on a revolving base that moves and revolves and scanner takes multiple shots for covering a 360-degree view of the object. The base may not withstand bigger or heavier object. Further, the scanner is stationary therefore may not be able to take shots of the object from different angles.

Further limitations may include that a higher number of pictures need to be taken by a user for making a 360-degree view. Also the 3D scanners take more time for taking or capturing pictures. Further, a stitching time is more for combining the more number of pictures (or images). Similarly, the processing time for processing the more number of pictures increases. Further, because of more number of pictures, the final scanned picture becomes heavier in size and may require more storage space. In addition, the user may have to take shots manually that may increase the user's effort for scanning of the objects and environment. Further, the present 3D scanner does not provide real-time merging of point clouds and image shots. Also a final product is presented to the user, there is no way to show intermediate process of rendering to the user. Further, in existing systems, some processor in a lab does the rendering of the object.

### SUMMARY

In light of above discussion, there exists need for better techniques for automatic scanning and primarily three-dimensional (3D) scanning of objects without any manual intervention. The present disclosure provides robotic systems and automatic scanning methods for 3D scanning of objects including at least one of symmetrical and unsymmetrical objects.

An objective of the present disclosure is to provide a desktop scanning system for scanning an object.

An objective of the present disclosure is to provide an autonomous 3D scanning system and automatic scanning method for scanning a plurality of objects.

Another objective of the present disclosure is to provide portable 3D scanning systems and scanning methods for scanning of a plurality of objects. The portable 3D scanning system may move around the object to take a number of image shots for covering a 360-Degree view of the object. The object may remain stationary. Further, the portable 3D scanning system may include a high speed CMOS camera having a CMOS microcontroller. The CMOS microcontroller may determine a distance to the object and may move around the object according to the distance. In some embodiments, the distance may be determined by using a single vision camera.

Another objective of the present disclosure is to provide a portable 3D scanner comprising wheels for moving from one position to other.

Another objective of the present disclosure is to provide a portable 3D scanner comprising a database including a number of pre-stored 3D scanned images.

A further objective of the present disclosure is to provide a portable 3D scanner for scanning object. The portable 3D scanner is easy to use and is of a compact size.

A further objective of the present disclosure is to provide a portable 3D scanner comprising a processor configured to process and stitch a number of image shots for generating a 3D scanned image.

Another objective of the present disclosure is to provide a portable 3D scanner including a high speed CMOS sensor/camera for taking a plurality of image shots.

Another objective of the present disclosure is to provide a self-moving portable 3D scanning system for scanning of a plurality of objects.

Another objective of the present disclosure is to provide an autonomous desktop 3D scanning system for scanning a plurality of objects. The objects may include symmetric and asymmetric objects having uneven surfaces. The objects may be big in size and heavy in weight.

Another objective of the present disclosure is to provide desktop 3D scanning systems and automatic scanning methods for three-dimensional scanning and rendering of objects in real-time.

A yet another objective of the present disclosure is to provide autonomous portable 3D scanning systems and scanning methods for generating high quality 3D scanned images of an object in less time.

Another objective of the present disclosure is to provide an autonomous 3D scanning system for covering a 360-Degree view of an object for scanning.

Another objective of the present disclosure is to provide a desktop scanner that can be controlled via a mobile device from a remote location for scanning of objects.

Another objective of the present disclosure is to provide an autonomous portable 3D scanning system for scanning objects by moving around the objects automatically.

The present disclosure also provides autonomous portable 3D scanning systems and methods for generating a good quality 3D model including scanned images of object(s) with a less number of images or shots for completing a 360-degree view of the object.

An embodiment of the present disclosure provides a portable 3D scanner including at least one camera for capturing a plurality of image shots of an object for scanning, wherein the at least one camera is mounted on a stack structure configured to expand and close for adjusting a height and an angle of the at least one camera for taking at least one image shot of the plurality of image shots of the object, wherein the stack structure is mounted over a base comprising one or more wheels for movement of the base to one or more positions. The portable 3D scanner further comprising a processor for: determining a laser center of the object from a first image shot of the plurality of image shots; determining a radius between the object and the a center of the at least one camera, wherein the base moves around the object based on the radius for covering a 360-Degree view of the object; and processing and stitching the plurality of image shots for generating a 3D scanned image of the object.

According to an aspect of the present disclosure, the processor is further configured to determine the one or more position coordinates for taking the plurality of image shots of an object for completing the 360-Degree view of the object; and enable a movement of the base comprising the stack structure including the at least one camera from an initial position to the one or more positions.

According to another aspect of the present disclosure, the processor processes the plurality of image shots by comparing the at least one image shot with a plurality of pre-stored 3D scanned images of a database, using a matched image for generating a 3D scanned image when a match corresponding to the at least one image shot is available in the database, else merging and processing the point cloud with the at least one image shot for generating the 3D scanned image. The database may be located in a cloud network.

In some embodiments, the 3D portable scanner comprising a depth sensor for creating a point cloud of the object, wherein the depth sensor comprises at least one of a RGB-D camera, a Time-of-Flight (ToF) camera, a ranging camera, and a Flash LIDAR.

According to another aspect of the present disclosure, the base is configured to rotate and revolve based on the laser center and the radius, this in turn moves the at least one camera.

According to another aspect of the present disclosure, the at least one camera comprises a high speed CMOS (complimentary metal-oxide semiconductor) camera.

According to another aspect of the present disclosure, the at least one camera comprises a high speed CMOS (complimentary metal-oxide semiconductor) camera, the high speed CMOS camera may use a single vision distance calculation method for determining a distance from the object.

Another embodiment of the present disclosure provides an autonomous desktop 3D scanning system including a scanner comprising a camera for capturing a plurality of image shots of an object, wherein the camera comprising a high speed CMOS (complimentary metal-oxide semiconductor) camera is mounted on an expandable ladder structure, wherein the expandable ladder structure is configured to expand and close for adjusting a height and an angle of the camera for taking at least one image shot of the object, wherein the ladder structure is located over a base comprising one or more wheels for movement of the base to the one or more positions, wherein the scanner self-move to the one or more positions. Further, the autonomous desktop 3D scanning system comprises a processor for determining a laser center of the object from a first image shot of the plurality of image shots; determining a radius between the object and the a center of the at least one camera, wherein the base moves around the object based on the radius for covering a 360-Degree view of the object; creating a point cloud of the object; and processing and merging the plurality of image shots with the point cloud for generating a 3D scanned image of the object.

Another embodiment of the present disclosure provides a method for 3D scanning of an object. The method includes capturing a plurality of image shots of the object, wherein at least one camera captures the plurality of image shots of the object for scanning, wherein the at least one camera is mounted on a stack structure configured to expand and close for adjusting a height and an angle of the at least one camera for taking at least one image shot of the plurality of image shots of the object, wherein the stack structure is mounted over a base comprising one or more wheels for movement of the base to the one or more positions. The method further includes determining a laser center of the object from a first image shot of the plurality of image shots. The method also includes determining a radius between the object and the a center of the at least one camera, wherein the base moves around the object based on the radius for covering a 360-Degree view of the object; and processing and stitching the plurality of image shots for generating a 3D scanned image of the object.

In some embodiments, the database including a plurality of 3D scanned images and may be located in a cloud network.

According to another aspect of the present disclosure, the portable 3D scanner may be a compact device configured to scan an object.

According to another aspect of the present disclosure, the portable 3D scanner may be controllable via a mobile device from a remote location. In some embodiments, a user may control the portable 3D scanner via an application running on the mobile device.

According to another aspect of the present disclosure, the one or more cameras takes the one or more shots of the object one by one based on the laser center co-ordinate and a relative width of the first shot.

According to an aspect of the present disclosure, a portable 3D scanner takes a first shot (i.e. N1) of an object and based on that, a laser center co-ordinate may be defined for the object.

According to an aspect of the present disclosure, the portable 3D scanner comprises a database including a number of 3D scanned images. The pre-stored images are used while rendering of an object for generating a 3D scanned image. Using pre-stored image may save processing time.

According to an aspect of the present disclosure, the portable 3D scanner may take few shots for completing a 360-degree view or a 3D view of the object or an environment.

According to an aspect of the present disclosure, the matching of a 3D scanned image may be performed by using a suitable technique comprising, but are not limited to, a machine vision matching, artificial intelligence matching, pattern matching, and so forth. In some embodiments, only scanned part is matched for finding a 3D scanned image from the database.

According to an aspect of the present disclosure, the matching of the image shots is done based on one or more parameters comprising, but are not limited to, shapes, textures, colors, shading, geometric shapes, and so forth.

According to another aspect of the present disclosure, the laser center co-ordinate is kept un-disturbed while taking the plurality of shots of the object.

According to another aspect of the present disclosure, the portable 3D scanner on a real-time basis processes the taken shots. In some embodiments, the taken shots and images may be sent to a processor in a cloud network for further processing in a real-time.

According to another aspect of the present disclosure, the plurality of shots is taken one by one with a time interval between two subsequent shots.

According to another aspect of the present disclosure, the portable 3D scanner further includes a self-learning module configured to self-review and self-check a quality of the scanning process and of the rendered map.

According to another aspect of the present disclosure, the base comprises a motorized 360-degree revolving base.

According to yet another aspect of the present disclosure, the portable 3D scanner includes an LED light indicator for indicating a status of scanning process.

According to another aspect of the present disclosure, an object may be placed on a surface in front of the portable 3D scanner and the scanner may revolves around the object to cover a 360-degree view of the object while scanning.

According to another aspect of the present disclosure, the portable 3D scanner comprises a high-speed stacked CMOS sensor.

According to another aspect of the present disclosure, the portable 3D scanner comprises a single vision camera for measuring a distance from an object. The single vision camera may determine a distance and a radius between itself and the object.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 illustrates an exemplary environment where various embodiments of the present disclosure may function;

FIG. 2A illustrates an exemplary portable 3D scanner comprising a stack structure in a closed configurations, in accordance with various embodiments of the present disclosure;

FIG. 2B illustrates the exemplary portable 3D scanner of FIG. 2A comprising the stack structure in an expanded configurations, in accordance with various embodiments of the present disclosure;

FIGS. 3A-3B illustrate a flowchart of a method for three-dimensional (3D) scanning of an object, in accordance with an embodiment of the present disclosure; and

FIG. 4 illustrates a method for determining a distance from an object by using a single vision camera/lens comprising a lens, according to an embodiment of the present disclosure.

The headings used herein are for organizational purposes only and are not meant to be used to limit the scope of the description or the claims. As used throughout this application, the word “may” is used in a permissive sense (i.e., meaning having the potential to), rather than the mandatory sense (i.e., meaning must). To facilitate understanding, like reference numerals have been used, where possible, to designate like elements common to the figures.

### DETAILED DESCRIPTION

The presently disclosed subject matter is described with specificity to meet statutory requirements. However, the description itself is not intended to limit the scope of this patent. Rather, the inventors have contemplated that the claimed subject matter might also be embodied in other ways, to include different steps or elements similar to the ones described in this document, in conjunction with other present or future technologies. Moreover, although the term “step” may be used herein to connote different aspects of methods employed, the term should not be interpreted as implying any particular order among or between various steps herein disclosed unless and except when the order of individual steps is explicitly described.

Reference throughout this specification to “a select embodiment”, “one embodiment” or “an embodiment” means that a particular feature, structure, or characteristic described in connection with the embodiment is included in at least one embodiment of the disclosed subject matter. Thus, appearances of the phrases “a select embodiment” “in one embodiment” or “in an embodiment” in various places throughout this specification are not necessarily referring to the same embodiment.

Furthermore, the described features, structures, or characteristics may be combined in any suitable manner in one or more embodiments. In the following description, numerous specific details are provided, to provide a thorough understanding of embodiments of the disclosed subject matter. One skilled in the relevant art will recognize, however, that the disclosed subject matter can be practiced without one or more of the specific details, or with other methods, components, materials, etc. In other instances, well-known structures, materials, or operations are not shown or described in detail to avoid obscuring aspects of the disclosed subject matter.

All numeric values are herein assumed to be modified by the term “about,” whether or not explicitly indicated. The term “about” generally refers to a range of numbers that one of skill in the art would consider equivalent to the recited value (i.e., having the same or substantially the same function or result). In many instances, the terms “about” may include numbers that are rounded to the nearest significant figure. The recitation of numerical ranges by endpoints includes all numbers within that range (e.g., 1 to 5 includes 1, 1.5, 2, 2.75, 3, 3.80, 4, and 5).

As used in this specification and the appended claims, the singular forms “a,” “an,” and “the” include or otherwise refer to singular as well as plural referents, unless the content clearly dictates otherwise. As used in this specification and the appended claims, the term “or” is generally employed to include “and/or,” unless the content clearly dictates otherwise.

The following detailed description should be read with reference to the drawings, in which similar elements in different drawings are identified with the same reference numbers. The drawings, which are not necessarily to scale, depict illustrative embodiments and are not intended to limit the scope of the disclosure.

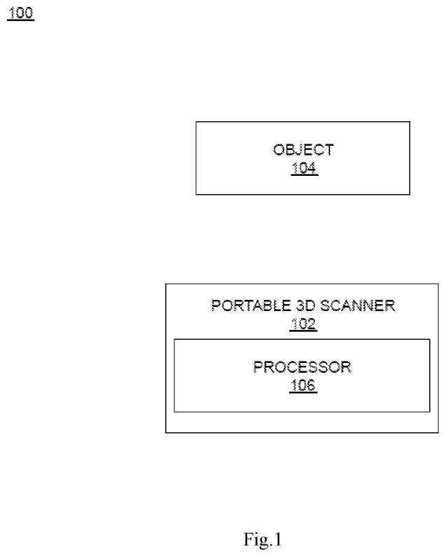

FIG. 1 illustrates an exemplary environment 100 where various embodiments of the present disclosure may function. As shown, the environment 100 primarily includes a portable 3D scanner 102 including a processor 106. The portable 3D scanner 102 is configured to scan an object 104. The object 104 may be a symmetrical object and an unsymmetrical object having uneven surface. Though only one object 104 is shown, but a person ordinarily skilled in the art will appreciate that the environment 100 may include more than one object 104. The portable 3D scanner 102 is configured to take a plurality of image shots of the object 104. The processor 106 may process and stitch the image shots for generating a 3D scanned image of the object 104. In some embodiments, the portable 3D scanner 102 may be a device or a combination of multiple devices, configured to analyse a real-world object or an environment and may collect/capture data about its shape and appearance, for example, colour, height, length width, and so forth. The processor 106 may use the collected data to construct a digital three-dimensional model.

According to an embodiment of the present disclosure, the portable 3D scanner 102 comprises a single vision camera for measuring a distance from an object. The single vision camera may determine a distance (described in detail in FIG. $) and/or a radius between itself (i.e. 102) and the object 104. Based on the determination of the distance, the portable 3D scanner 102 may move or revolve around the object for taking the image shots.

Further, the processor 106 may define a laser center co-ordinate for the object 104 from a first shot of the image shots. Further, the processor 106 may be configured to define a radius between the object 104 and the portable 3D scanner 102. Further, the processor 106 may define the exact position for taking the subsequent shot without disturbing the laser center co-ordinate for the object 104. The exact position for taking the subsequent shot is defined without disturbing the laser center co-ordinate for the object 104. Further, the processor 106 is configured to define a new position co-ordinate of the based on the laser center co-ordinate and the relative width of the shot. The portable 3D scanner 102 may be configured to self-move to the exact position to take the one or more shots of the object 104 one by one based on an indication or the feedback. In some embodiments, the portable 3D scanner 102 may take subsequent shots of the object 104 one by one based on the laser center co-ordinate and a relative width of a first shot of the shots. Further, the subsequent one or more shots may be taken one by one after the first shot. For each of the one or more, the portable 3D scanner 102 may include a laser light to point a green laser light on an exact position or may provide feedback about the exact position to take an image shot.

In some embodiments, the processor 106 is configured create point cloud of the object 104. Further, the processor 106 may process the point cloud(s) and image shots for rendering of the object 104. The portable 3D scanner 102 may include a database that may store a number of 3D scanned images. In some embodiments, the processor 106 may search for a matching 3D scanned image corresponding to an image shot in the pre-stored 3D scanned images in a database (not shown) and may use the same for generating a 3D scanned image of the object 104.

The portable 3D scanner 102 may include wheels for self-moving to the exact position. Further, the portable 3D scanner 102 may automatically stop at the exact position for taking the shots. The portable 3D scanner 102 may capture shots precisely from different angles. In some embodiments, a user (not shown) may control movement of the portable 3D scanner 102 via a remote controlling device or a mobile device like a phone.

In some embodiments, the processor 106 is configured to determine an exact position for capturing one or more image shots of the object 104. The portable 3D scanner 102 may be a self-moving device comprising at least one wheel. The portable 3D scanner 102 is capable of moving from a current position to the exact position. The portable 3D scanner 102 comprising a depth sensor such as an RGBD camera is configured to create a point map/cloud of the object 104. The point cloud may be a set of data points in some coordinate system. Usually, in a three-dimensional coordinate system, these points may be defined by X, Y, and Z coordinates, and may intend to represent an external surface of the object 104.

Further, the portable 3D scanner 102 comprising a high speed CMOS camera is configured to capture one or more image shots of the object 104 for generating a 3D model including at least one image of the object 104. In some embodiments, the portable 3D scanner 102 is configured to capture less number of images of the object 104 for completing a 360-degree view of the object 104. The 3d scanner 102 may revolve around the object 104 and the object 104 may remain stationary. Further, in some embodiments, the processor 106 may be configured to generate 3D scanned models and images of the object 104 by processing/merging the point cloud with the image shots.

Further, the processor 106 may be configured to process the image shots in real-time. First the processor 106 may search for a matching 3D scanned image corresponding to the one or more image shots in the pre-stored 3D scanned images of the database based on one or more parameters. The matching may be performed based on the one or more parameters including, but are not limited to, geometric, shapes, textures, colors, shading, and so forth. Further, the matching may be performed using various techniques comprising machine vision matching, and artificial intelligence (AI) matching, and so forth. And if a matching 3D scanned image is found then the portable 3D scanner 102 may use the same for generating the complete 3D scanned image for the object 104. This may save the time required for generating the 3D model or 3D scanned image. On the other hand when no matching 3D scanned image is found, then the portable 3D scanner 102 may merge and process the multiple image shots with the point cloud of the object 104 to generate at least one high quality 3D scanned image of the object 104. The processor 106 may merge and process the point cloud and the one or more shots for rendering of the object 104. The portable 3D scanner 102 may self-review and monitor a quality of a rendered map of the object 104. If the quality is not good, the portable 3D scanner 102 may take one or more measures like re-scanning the object 104.

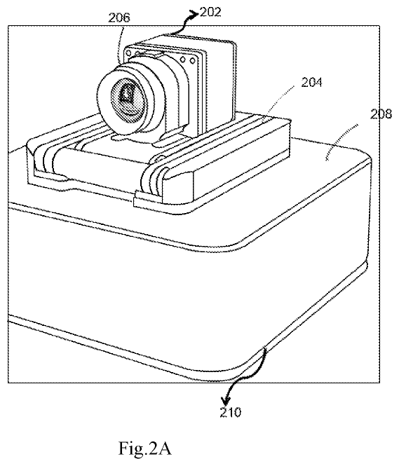

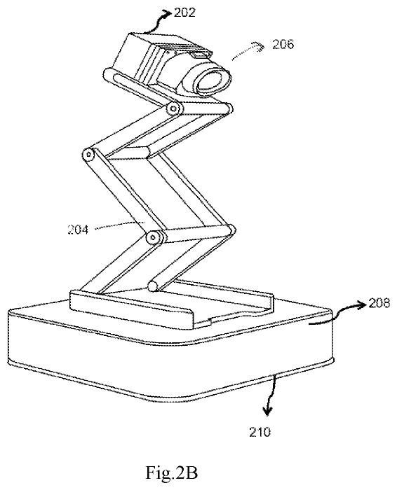

FIG. 2A illustrates an exemplary portable 3D scanner 202 comprising a stack structure 204 in a closed configuration, in accordance with an embodiment of the present disclosure. The portable 3D scanner includes at least one camera 206 for capturing a plurality of image shots of an object, such as the object 104 of FIG. 1, for scanning. The camera 206 may comprise a single vision camera for measuring a distance from an object. The single vision camera may determine a distance and a radius between itself and the object 104.

The camera 206 may be mounted on the stack structure 204. The stack structure 204 may be configured to expand and close for adjusting a height and an angle of the camera 206 for taking at least one image shot of the object 104. A base 208 including the stack structure (or a ladder structure) 204 is configured to rotate and revolve based on the laser center and the radius, this in turn moves the at least one camera 206. The camera 206 may comprise a high speed CMOS (complimentary metal-oxide semiconductor) camera. FIG. 2A shows the stack structure 204 in a closed configuration. The stack structure 204 may be mounted over the base 208 comprising one or more wheels 210 for movement of the base 208 to the one or more positions. The portable 3D scanner 202 may include one or more than one wheels 210. The wheels may help the portable 3D scanner 202 to move from current position to the one or more positions for capturing various image shots of the object 104. The wheels may be of rubber, wood, metal or combination of these. The portable 3D scanner 202 may also be referred as an autonomous desktop 3D scanning system without changing its meaning.

FIG. 2B illustrates the exemplary portable 3D scanner 202 of FIG. 2A comprising the stack structure 204 in an expanded configuration, in accordance with various embodiments of the present disclosure. The object 104 may be placed in front of the portable 3D scanner 202 for scanning. The portable 3D scanner 202 may revolve around the object 104 for taking a plurality of shots and covering the object 104 from different angles. The stack structure 204 may expand and adjust a height of the camera 206 while clicking the image shots.

Though not visible, but the portable 3D scanner 202 includes a processor for determining a laser center of the object 104 from a first image shot of the image shots. The processor is also configured to determine a radius between the object 104 and a center of the at least one camera 206. The base 208 may move around the object 104 based on the radius for covering a 360-Degree view of the object 104. The processor may process and stitch the plurality of image shots for generating a 3D scanned image of the object 104. In some embodiments, the processor is configured to determine the one or more position coordinates for taking the plurality of image shots of the object 104 for completing the 360-Degree view of the object 104. The processor may also enable a movement of the base 208 from an initial position to the one or more positions.

In some embodiments, the processor processes the plurality of image shots by comparing the at least one image shot with a plurality of pre-stored 3D scanned images of a database, using a matched image for generating a 3D scanned image when a match corresponding to the at least one image shot is available in the database, else merging and processing the point cloud with the at least one image shot for generating the 3D scanned image.

In some embodiments, the portable 3D scanner 202 may include a depth sensor for creating a point cloud of the object, wherein the depth sensor comprises at least one of a RGB-D camera, a Time-of-Flight (ToF) camera, a ranging camera, and a Flash LIDAR.

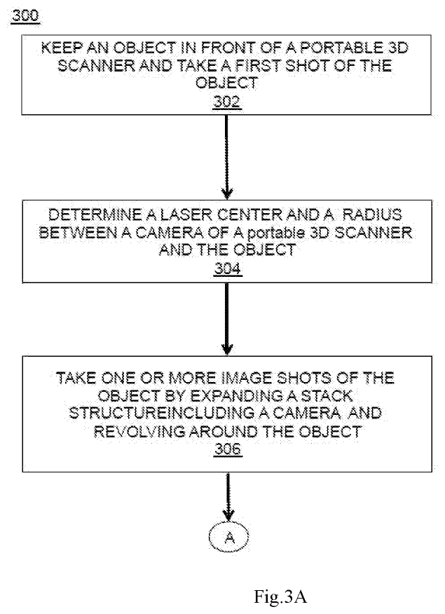

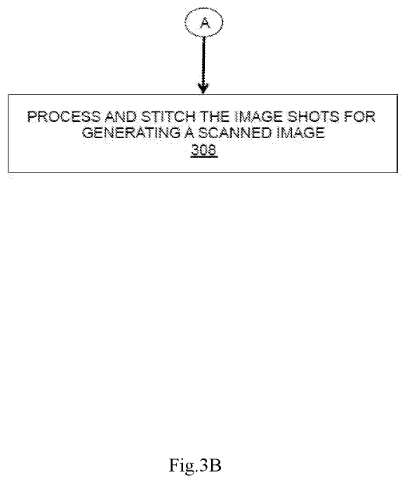

FIGS. 3A-3B illustrate a flowchart of a method 300 for three-dimensional (3D) scanning of an object, in accordance with an embodiment of the present disclosure. At step 302, an object is kept in front of a portable 3D scanner and a first shot of the object is taken. Then at step 304, a laser center of the object and a radius between a center of a camera of the portable device and the object is determined. At step 306, one or more image shots of the object are taken based on the radius and laser center by expanding a stack structure of the 3D scanner. The camera of the portable 3D scanner may take the image shots and the portable 3D scanner may revolve around the object for taking a 360-degree view of the object by capturing multiple image shots of the object from different angles. The camera may be a high speed CMOS camera. The stack may expand or extend automatically so that the camera may click the image shots of the object from all possible angles. In some embodiments, the portable 3D scanner may include an led light indicator for indicating a position from where the image shots should be captured. The portable 3D scanner is configured to self-move to the positions as indicated by the led light. In alternative embodiments, a feedback module of the portable 3D scanner may provide a feedback about the positions for taking image shots. Thereafter, at step 308, the image shots are processed and stitched for generating a 3D scanned image of the object. A processor of the portable 3D scanner may process and stitch the image shots for generating the 3D scanned image.

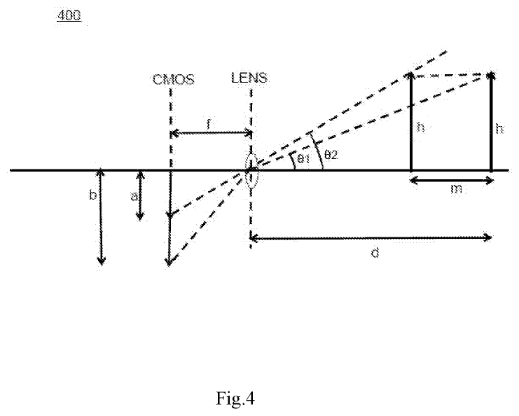

FIG. 4 illustrate a method for determining a distance from an object 202 by using a single vision camera 204 comprising a lens 206, according to an embodiment of the present disclosure. The single vision camera 204 may be comprises a CMOS microcontroller 208. As shown, “h” is a height of the object 202; “f” is a distance between the microcontroller 208 and the lens 206 of the camera 204. The object 202 may be moved from a first position towards the lens 206 to a second position. In some embodiments, the camera 204 may be moved towards the object 202 rather than object 202 moving from the first to the second position. Initially, the object 202 may be at a distance “d” from the lens 206. The object 202 is moved a distance “m” towards the camera 204 such that a distance between the camera lens 206 and the object becomes “d-m”. When the object 202 is at a “d” distance from the lens 206, an image of height “a” is formed, and when a distance between the object and the lens is “d-m” then an image of height “b” is formed. “81” may be an angle formed with a tip of the object from a center of the lens 206 when the object 202 is at distance “d” from the lens 206. “82” may be an angle formed with a tip of the object 202 from the center of the lens 206 when the object 202 is at a distance “d-m” from the lens 206. The method 400 includes following steps for calculating the distance between the camera 204 and the object 202 by using the following equations 1 and 2.

a/f=tan θ1=h/d Equation 1:

b/f=tan θ2=h/(d−m) Equation 2:

dividing equation 2 by the equation 1:
Step 1: a/b=h/d×(d−m)/h
Step 2: a/b=(d−m)/d=1−m/d
Step 3: m/d=1=a/b
Step 4: d=m/(1−a/b)

Therefore, by following the above steps 1-4 and by using Equations 1 & 2, the distance “d” may be determined by using a single vision camera (or lens). The portable 3D scanner may use the distance for determining a moving path while taking one or more image shots of the object such as the object 104.

The present disclosure provides a portable 3D scanner for scanning of objects.

According to an aspect of the present disclosure, a portable 3D scanner comprises a database including a number of 3D scanned images. The pre-stored images are used while rendering of an object for generating a 3D scanned image. Using pre-stored image may save processing time.

The present disclosure enables storing of a final 3D scanned image of the object on a local database or on a remote database. The local database may be located in a portable 3D scanner. The remote database may be located in a cloud network.

The system disclosed in the present disclosure also provides better scanning of the objects in less time. Further, the system provides better stitching while processing of the point clouds and image shots. The system results in 100% mapping of the object, which in turn results in good quality scanned image(s) of the object without any missing parts.

The system disclosed in the present disclosure produces scanned images with less error rate and provides 3D scanned images in less time.

The disclosed systems and methods allow a user to control the portable 3D scanner or an autonomous desktop scanning system including a scanner and a processor from a remote location via a mobile device or an application running on the mobile device like a smart phone.

The disclosed scanner is compact and easy to use for a person.

Embodiments of the disclosure are also described above with reference to flowchart illustrations and/or block diagrams of methods and systems. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the acts specified in the flowchart and/or block diagram block or blocks. These computer program instructions may also be stored in a computer-readable memory that can direct a computer or other programmable data processing apparatus to operate in a particular manner, such that the instructions stored in the computer-readable memory produce an article of manufacture including instruction means which implement the acts specified in the flowchart and/or block diagram block or blocks. The computer program instructions may also be loaded onto a computer or other programmable data processing apparatus to cause a series of operations to be performed on the computer or other programmable apparatus to produce a computer implemented process such that the instructions which execute on the computer or other programmable apparatus provide steps for implementing the acts specified in the flowchart and/or block diagram block or blocks.

In addition, methods and functions described herein are not limited to any particular sequence, and the acts or blocks relating thereto can be performed in other sequences that are appropriate. For example, described acts or blocks may be performed in an order other than that specifically disclosed, or multiple acts or blocks may be combined in a single act or block.

While the invention has been described in connection with what is presently considered to be the most practical and various embodiments, it is to be understood that the invention is not to be limited to the disclosed embodiments, but on the contrary, is intended to cover various modifications and equivalent arrangements.

What is claimed is:

1. A portable 3D scanner comprising:
at least one camera for capturing a plurality of image shots of an object for scanning, wherein the at least one camera is mounted on a stack structure configured to expand and close for adjusting a height and an angle of the at least one camera for taking at least one image shot of the plurality of image shots of the object, wherein the stack structure is mounted over a base comprising one or more wheels for movement of the base to the one or more positions; and
a processor for:
determining a laser center of the object from a first image shot of the plurality of image shots;
determining a radius between the object and a center of the at least one camera, wherein the base moves around the object based on the radius for covering a 360-Degree view of the object; and
processing and stitching the plurality of image shots for generating a 3D scanned image of the object.

2. The portable 3D scanner of claim 1, wherein the processor is configured to determine the one or more position coordinates for taking the plurality of image shots of the object for completing the 360-Degree view of the object; and enable a movement of the base from an initial position to the one or more positions.

3. The portable 3D scanner of claim 1 wherein the processor processes the plurality of image shots by comparing the at least one image shot with a plurality of pre-stored 3D scanned images of a database, using a matched image for generating a 3D scanned image when a match corresponding to the at least one image shot is available in the database, else merging and processing the point cloud with the at least one image shot for generating the 3D scanned image.

4. The portable 3D scanner of claim 1 further comprising a depth sensor for creating a point cloud of the object, wherein the depth sensor comprises at least one of a RGB-D camera, a Time-of-Flight (ToF) camera, a ranging camera, and a Flash LIDAR.

5. The portable 3D scanner of claim 1, wherein the base is configured to rotate and revolve based on the laser center and the radius, this in turn moves the at least one camera.

6. The portable 3D scanner of claim 1, wherein the at least one camera comprises a high speed CMOS (complimentary metal-oxide semiconductor) camera.

7. An autonomous desktop 3D scanning system comprising:
a scanner comprising a camera for capturing a plurality of image shots of an object, wherein the camera comprising a high speed CMOS (complimentary metal-oxide semiconductor) camera is mounted on an expandable ladder structure, wherein the expandable ladder structure is configured to expand and close for adjusting a height and an angle of the camera for taking at least one image shot of the object, wherein the ladder structure is located over a base comprising one or more wheels for movement of the base to the one or more positions, wherein the scanner self-move to the one or more positions; and
a processor for:
determining a laser center of the object from a first image shot of the plurality of image shots;
determining a radius between the object and the a center of the at least one camera, wherein the base moves around the object based on the radius for covering a 360-Degree view of the object;
creating a point cloud of the object; and
processing and merging the plurality of image shots with the point cloud for generating a 3D scanned image of the object.

8. The autonomous desktop 3D scanning system of claim 7, wherein the processor is further configured to determine the one or more position coordinates for taking the plurality of image shots of the object for completing the 360-Degree view of the object; and enabling movement from an initial position to the one or more positions.

9. The autonomous desktop 3D scanning system of claim 7, wherein the processor processes the plurality of image shots by comparing the at least one image shot with a plurality of pre-stored 3D scanned images of a database, using a matched image for generating a 3D scanned image when a match corresponding to the at least one image shot is available in the database, else merging and processing the point cloud with the at least one image shot for generating the 3D scanned image.

10. The autonomous desktop 3D scanning system of claim 9, wherein the database is located in a cloud network.

11. The autonomous desktop 3D scanning system of claim 7, wherein the base is configured to rotate and revolve, this in turn moves the at least one camera.

12. A method for 3D scanning of an object, comprising:
keeping the object in front of a portable 3D scanner;
capturing a plurality of image shots of the object, wherein at least one camera captures the plurality of image shots of the object for scanning, wherein the at least one camera is mounted on a stack structure configured to expand and close for adjusting a height and an angle of the at least one camera for taking at least one image shot of the plurality of image shots of the object, wherein the stack structure is mounted over a base comprising one or more wheels for movement of the base to the one or more positions;
determining a laser center of the object from a first image shot of the plurality of image shots;
determining a radius between the object and the a center of the at least one camera, wherein the base moves around the object based on the radius for covering a 360-Degree view of the object; and
processing and stitching the plurality of image shots for generating a 3D scanned image of the object.

13. The method of claim 12 further comprising determining the one or more position coordinates for taking the plurality of image shots of the object for completing the 360-Degree view of the object; and enabling a movement of the base comprising the stack structure including the at least one camera from an initial position to the one or more positions.

14. The method of claim 12 further comprising processing the plurality of image shots by comparing the at least one image shot with a plurality of pre-stored 3D scanned images of a database, using a matched image for generating a 3D scanned image when a match corresponding to the at least one image shot is available in the database, else merging and processing the point cloud with the at least one image shot for generating the 3D scanned image.

15. The method of claim 12 further comprising creating a point cloud of the object, wherein a depth sensor for creating the point cloud of the object comprises at least one of a RGB-D camera, a Time-of-Flight (ToF) camera, a ranging camera, and a Flash LIDAR.

16. The method of claim 12 further comprising self-rotating and self-revolving around the object based on the laser center and the radius, this in turn moves the at least one camera.

17. The method of claim 12, wherein the at least one camera comprising high speed CMOS camera.

18. The method of claim 12, wherein the at least one camera comprises a single vision camera.
